(19) United States
(12) Patent Application Publication
(10) Pub. No.: US 2007/0103413 A1
(43) Pub. Date: May 10, 2007

(54) METHOD FOR TRANSMITTING CONTROL SIGNAL OF FLAT DISPLAY PANEL

(76) Inventors: Jen-Ta Yang, Taipei County (TW); Kuo-Chi Chen, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,876

(22) Filed: Feb. 26, 2006

(30) Foreign Application Priority Data
Nov. 10, 2005 (TW) 94139394

(51) Int. Cl. G09G 3/36

(52) U.S. Cl. 345/87

(57) ABSTRACT

A method for transmitting control signal of flat panel display is provided. The method is used for controlling a display panel module with a display control device. There is a transmission interface including a display data transmission channel between the display panel module and the display control device. The method includes the following steps: first, during data transmission, the display control device transmitting display data to the display panel module through the display data transmission channel; during blanking period, the display control device transmitting a control signal to control the display panel module by sharing the display data transmission channel.

### CROSS-REFERENCE TO RELATED APPLICATION

This application claims the priority benefit of Taiwan application serial no. 94139394, filed on Nov. 10, 2005. All disclosure of the Taiwan application is incorporated herein by reference.

### BACKGROUND OF THE INVENTION

1. Field of Invention

The present invention relates to a method for transmitting control signal. More particularly, the present invention relates to a method for transmitting control signal of a flat display panel.

2. Description of Related Art

Nowadays, flat display panels, e.g. LCD panels, have been widely used. LCD panels are widely used in electronic products related to our daily life, such as LCDs of laptop computers or desktop computers and LCD TVs, because LCD panels have such advantages as lower power consumption, smaller in size and lighter in weight, higher resolution, higher color saturation, and longer life-span etc. This is resulting from the improvement of semiconductor technology.

Generally speaking, display data for driving an LCD panel are transmitted between a flat display panel and the driving/control circuit through a transmission interface, e.g. a low voltage differential signal (LVDS) transmission interface. To control the panel, e.g. performing dynamic image adjustment or panel attribute dynamic adjustment etc., one to multiple control lines have to be laid out. This method will increase the pins of the IC, the layout area of the circuit board, and the manufacturing cost, consequentially.

Thus, a method of controlling flat display panel without increasing the pins of the IC and the layout area of the circuit board needs to be provided.

### SUMMARY OF THE INVENTION

Accordingly, the present invention is directed to provide a method for transmitting control signal of flat display panel to reduce the pins of the IC, the layout area of the circuit board, and the manufacturing cost.

The present invention provides a method for transmitting control signal of flat display panel, which allows a display control device to control a display panel module. There is a transmission interface including a display data transmission channel between the display panel module and the display control device. The method includes the following steps. First, during a data transmission period, the display control device transmits display data to the display panel module through the display data transmission channel. During a blanking period, the display control device transmits control signal to control the display panel module by sharing the display data transmission channel.

In the present invention, since a display data transmission channel for transmitting display data between the display control device and the display panel module is adopted, and the display data transmission channel is shared for transmitting control signal to control the display panel module during blanking period, the pins of the IC, the layout area of the circuit board, and the manufacturing cost can all be reduced, accordingly.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram, illustrating the method for transmitting control signal of a flat display panel according to an embodiment of the present invention.

FIG. 2 is a clock diagram of a conventional panel transmission interface used in the device as shown in FIG. 1.

FIG. 3 is a clock diagram, schematically illustrating the method for transmitting control signal of a flat display panel according to an embodiment of the present invention.

FIG. 4 is a flowchart, schematically illustrating the method for transmitting control signal of a flat display panel according to an embodiment of the present invention.

FIG. 5 is a flowchart, schematically illustrating the method for transmitting control signal of a flat display panel according to an embodiment of the present invention.

FIG. 6 is a flowchart, schematically illustrating the method for transmitting control signal of a flat display panel according to an embodiment of the present invention.

### DESCRIPTION OF EMBODIMENTS

In the conventional method, to control the panel, one to multiple control lines has to be laid out, additionally. This method will increase the pins of the IC, the layout area of the circuit board, and the manufacturing cost, consequentially. Thus, the present invention provides some embodiments to resolve the aforementioned problems. The purpose of panel control can be achieved without increasing the layout of the IC or the layout of the printed circuit board (PCB) by using the existing transmission channel, and the embodiments will be described in detail as following.

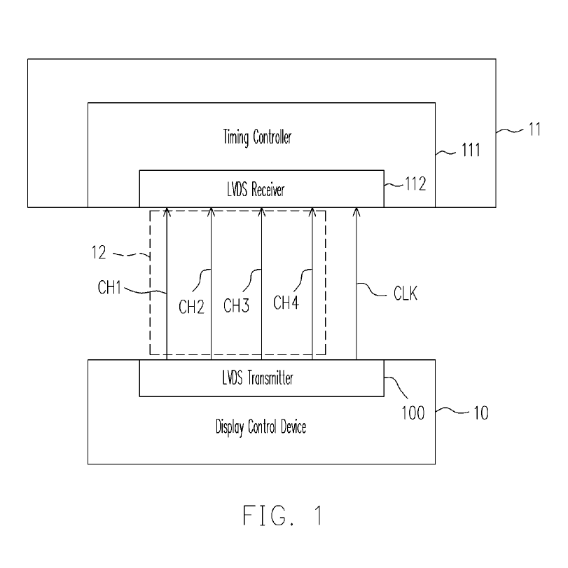

FIG. 1 is a schematic block diagram illustrating the method for transmitting control signal of a flat display panel according to an embodiment of the present invention. Generally speaking, the data transmission between the display control device and the display panel module is performed through, for example, a low voltage differential signal (LVDS) transmission interface. In FIG. 1, a display control device 10 (e.g. a scalar IC) and a display panel module 11 are included. The display panel module 11 includes a timing controller 111. The display control device 10 includes a LVDS transmitter 100. The timing controller 111 includes a LVDS receiver 112. In the present embodiment, a display data transmission channel 12 and a clock signal line CLK are included in the LVDS transmission interface, i.e. between the LVDS transmitter 100 and the LVDS receiver 112. The display data transmission channel 12 includes a first display data transmission channel CH1, a second display data transmission channel CH2, a third display data transmission channel CH3, and a fourth display data transmission channel CH4.

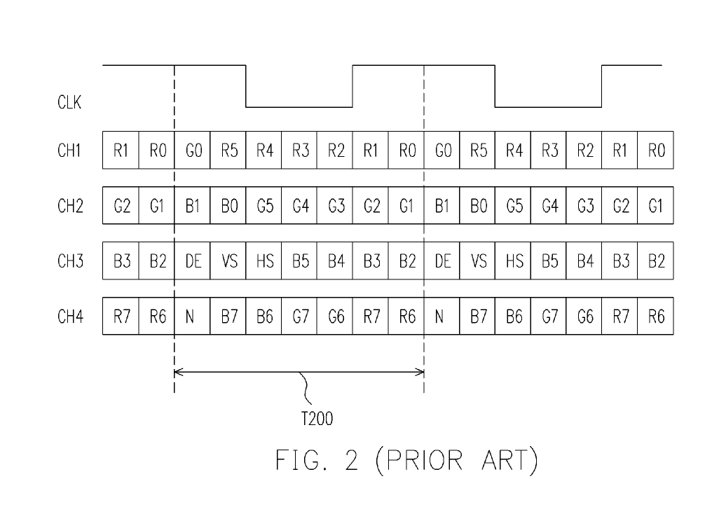

FIG. 2 is a clock diagram of a conventional panel transmission interface used in the device as shown in FIG. 1. Referring to both FIG. 1 and FIG. 2, in FIG. 2, the period T200 represents the transmission time of a pixel data, which starts from the midpoint of the period when the clock signal CLK is logic 1 until the midpoint of the next period when the clock signal is logic 1. R0-R7 represent the red subpixel data byte, G0-G7 represent the green subpixel data byte, B0-B7 represent the blue subpixel data byte, HS represents the horizontal synchronous flag, VS represents the vertical synchronous flag, DE represents the data enable flag, and N represents the unused bits in the conventional technology.

The transmission of the display panel module can be categorized into two modes, one is referred as a data enable mode, and the other one is referred as a horizontal vertical synchronous mode. Wherein, the data enable mode is completely referring to the data enable flag. It is a data transmission period when the data enable flag is, e.g. logic 1, and it is a period known generally as a blanking period if the data enable flag is, e.g. logic 0. In addition, the horizontal vertical synchronous mode is, for example, referring to the horizontal synchronous flag and the vertical synchronous flag. It is a data transmission period when the horizontal/vertical synchronous flags are, e.g. logic 1, and it is a blanking period when the horizontal synchronous flag or the vertical synchronous flag is, e.g. logic 0. During a blanking period, the red subpixel data byte R0-R7, the green subpixel data byte G0-G7, and the blue subpixel data byte B0-B7 transmitted in the display data transmission channel are all ignored by the display panel module.

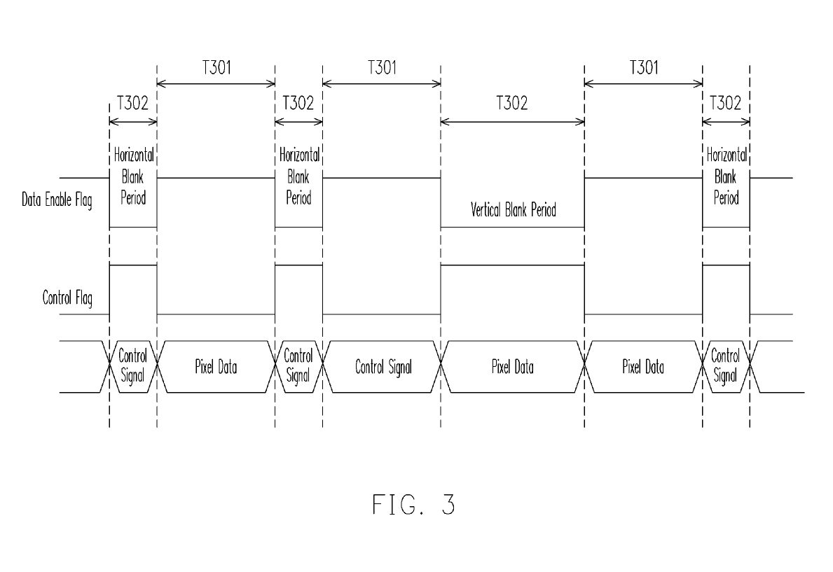

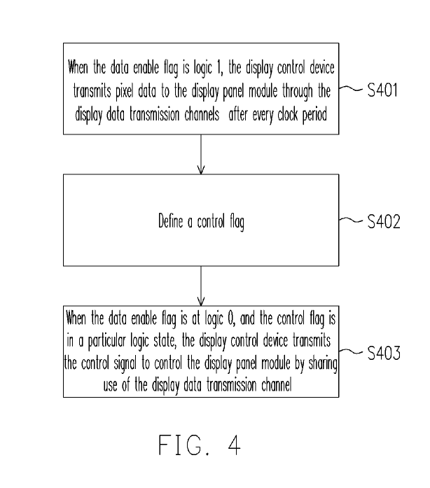

However, in the embodiments of the present invention, the control signal is transmitted during the blanking period and by using the same display data transmission channel 12 to control the display panel module. FIG. 3 is a clock diagram, schematically illustrating the method for transmitting control signal of a flat display panel according to an embodiment of the present invention. FIG. 4 is a flowchart, schematically illustrating the method for transmitting control signal of a flat display panel according to an embodiment of the present invention. Referring to FIGS. 3, 4, and 2, first, during a data transmission period T301, here the data enable mode is described as example, that is, when the data enable flag is at logic 1, the display control device transmits the pixel data to the display panel module through the display data transmission channels CH1-CH4 after every clock period (step S401). Next, the unused bit N is defined as a control flag (step S402). After that, when the data enable flag DE is at logic 0, i.e. during the blanking period T302, and the control flag is at a particular logic state, e.g. logic 1, the display control device transmits the control signal to control the display panel module by sharing use on the pixel data (R0-R7, G0-G7, B0-B7, HS, and VS) defined in the display data transmission channel 12 (step 403).

As described above, the structure of sharing the display data transmission channel is adopted in the embodiments of the present invention, thus, the purpose of controlling the flat display panel can be achieved without increasing the pins of the IC and the layout area of the circuit board.

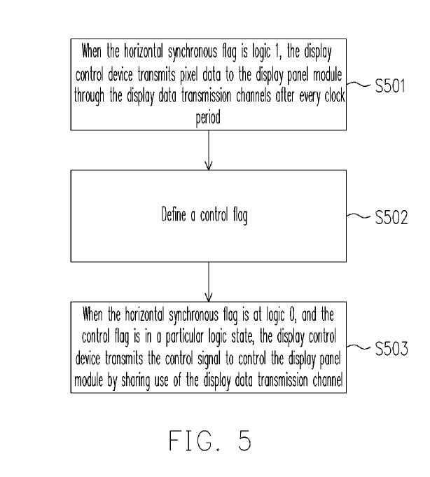

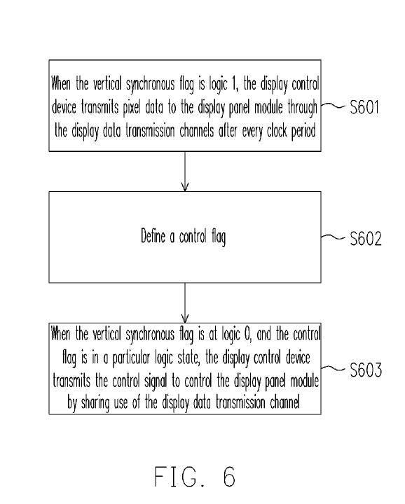

Similarly, if the horizontal vertical synchronous mode is applied to the embodiments of the present invention, it should be understood by those skilled in the art that the implementation method thereof is similar to what has been described above. It can be implemented by changing the original data enable flag to horizontal/vertical synchronous flags, as the flowcharts shown in FIG. 5 and FIG. 6 (steps S501-S503 and steps S601-S603), those will not be described again.

In overview, because the display data transmission channel for transmitting display data between the display control device and the display panel module is used in the present invention, and the control signal is transmitted to control the display panel module by sharing the display data transmission channel during blanking period, the pins of the IC, the layout area of the circuit board, and the manufacturing cost can be reduced accordingly.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for transmitting control signal of flat display panel, allowing a display control device to control a display panel module, wherein there is a transmission interface between the display panel module and the display control device, and the transmission interface includes a display data transmission channel, the method comprising:
during a data transmission period, the display control device transmitting a display data to the display panel module through the display data transmission channel; and
during a blanking period, the display control device transmitting a control signal to control the display panel module by sharing use on the display data transmission channel.

2. The method as claimed in claim 1, wherein the display panel module includes a timing controller and a LCD panel.

3. The method as claimed in claim 1, wherein the transmission interface includes a low voltage differential signal (LVDS) transmission interface.

4. The method as claimed in claim 1 further comprising:
during each clock period, defining the display data transmitted through the display data transmission channel as a pixel data.

5. The method as claimed in claim 4, wherein during a data transmission period, the display control device transmits the display data to the display panel module through the display data transmission channel, comprises:
during a data transmission period, the display control device transmitting the pixel data to the display panel module through the display data transmission channel after each clock period.

6. The method as claimed in claim 4, wherein the pixel data includes a red subpixel data byte, a green subpixel data byte, a blue subpixel data byte, a horizontal synchronous flag, a vertical synchronous flag, and a data enable flag.

7. The transmission method as claimed in claim 6, wherein the display data transmission channel includes a plurality of display data transmission sub-channels used respectively for transmitting the red subpixel data byte, the green subpixel data byte, the blue subpixel data byte, the horizontal synchronous flag, the vertical synchronous flag, and the data enable flag.

8. The transmission method as claimed in claim 6, wherein the data transmission period is defined as a period when the data enable flag is at a first state, and the blanking period is defined as a period when the data enable flag is at a second state.

9. The transmission method as claimed in claim 8, wherein during the blanking period, the display control device transmits the control signal to control the display panel module by sharing the display data transmission channel, comprises:
defining a control flag; and
when the data enable flag being at the second state and the control flag being at a particular logic state, the display control device transmitting the control signal to control the display panel module by sharing use on the pixel data defined in the display data transmission channel.

10. The transmission method as claimed in claim 6, wherein the data transmission period is defined as a period when the horizontal synchronous flag is at a first state, and the blanking period is defined as a period when the horizontal synchronous flag is at a second state.

11. The transmission method as claimed in claim 10, wherein during the blanking period, the display control device transmits the control signal to control the display panel module by sharing use on the display data transmission channel, comprises:
defining a control flag; and
when the horizontal synchronous flag being at the second state and the control flag being at a particular logic state, the display control device transmitting the control signal to control the display panel module by sharing the pixel data defined in the display data transmission channel.

12. The transmission method as claimed in claim 6, wherein the data transmission period is defined as a period when the vertical synchronous flag is at a first state, and the blanking period is defined as a period when the vertical synchronous flag is at a second state.

13. The transmission method as claimed in claim 12, wherein during the blanking period, the display control device transmits the control signal to control the display panel module by sharing use on the display data transmission channel, comprises:
defining a control flag; and
when the vertical synchronous flag being at the second state and the control flag being at a particular logic state, the display control device transmitting the control signal to control the display panel module by sharing use on the pixel data defined in the display data transmission channel.

14. The transmission method as claimed in claim 1, wherein the display control device is a scalar IC.
